(19) United States
(12) Patent Application Publication
(10) Pub. No.: US 2005/0261832 A1
(43) Pub. Date: Nov. 24, 2005

(54) Monitoring, tracking and recovery system for vehicles and other items

(76) Inventor: Michael Arnouse, Old Brookville, NY (US)

Correspondence Address: IP GROUP OF DLA PIPER RUDNICK GRAY CARY US LLP, 1650 MARKET ST, SUITE 4900, PHILADELPHIA, PA, 19103, US

(21) Appl. No.: 10/850,150

(22) Filed: May 20, 2004

(51) Int. Cl. G01C 21/26; G01S 1/00

(52) U.S. Cl. 701/213; 701/207; 342/357.07

(57) ABSTRACT

A monitoring, tracking and recover system comprises a communication device for a vehicle as well as other items and which communicates with a remote data communications terminal.

### FIELD OF THE INVENTION

The present invention relates generally to monitoring systems and more particularly to a monitoring system adapted for vehicles and other items.

### BACKGROUND OF THE INVENTION

Monitoring systems are utilized for a variety of different purposes, such as for home and automobile security. An example of an automobile security system is marketed under the name LoJack™, which comprises a small radio frequency transceiver hidden in the vehicle, and a unique code that is tied into the vehicle identification number (VIN). When a theft is reported to the police, a routine entry into the state police crime computer results in a match of the LoJack system's unique code against the state VIN database. This automatically activates the LoJack system in the car, which emits an inaudible signal that is received by law enforcement authorities who are equipped with vehicle tracking units.

There is a need for an improved monitoring, tracking and recovery system for vehicles and other items.

### SUMMARY OF THE INVENTION

The present invention comprises a monitoring, tracking and recovery system for vehicles, such as, for example, trailers, tankers, trains, aircraft and subways, as well as other items, such as for example, components of a vehicle, contents located on a vehicle or other items of personal or public property. In one embodiment, a communication device, such as a wireless transmitter, for instance a WiFi chip, is utilized in a designated area, such as in a hidden area on a vehicle or embedded in a vehicle registration sticker or inspection sticker, as examples. The WiFi chip, in turn, communicates with a scanner device, such as a portable scanner positioned at any desired location, such as road side on a highway, or provided in a mobile tracking unit, such as a police car. Alternatively, the scanner can be provided in a particular fixed location, such as a toll booth, check point or border crossing.

In another embodiment, alternatively, or in addition to the WiFi chip, a GPS chip is disposed in a location on a vehicle or other item, and it communicates with an external device, such as a scanner, to identify location of the given vehicle/item on which the GPS chip is mounted. In connection with a vehicle, the GPS chip may be powered by the vehicle itself, such as by connection to the motor or battery. Alternatively, the GPS chip can be powered by an auxiliary battery, such as located on the vehicle/items as well. In one exemplary embodiment, the GPS chip is mounted on a trailer of a vehicle and connects with the vehicle motor/battery when the trailer is in a mounted position hitched to the cab. In this embodiment, the GPS chip may alternatively be embedded in the vehicle inspection or registration sticker.

### DESCRIPTION OF THE DRAWINGS

FIG. 1 is an embodiment of the present invention.

FIG. 2 is another embodiment of the present invention.

### DETAILED DESCRIPTION

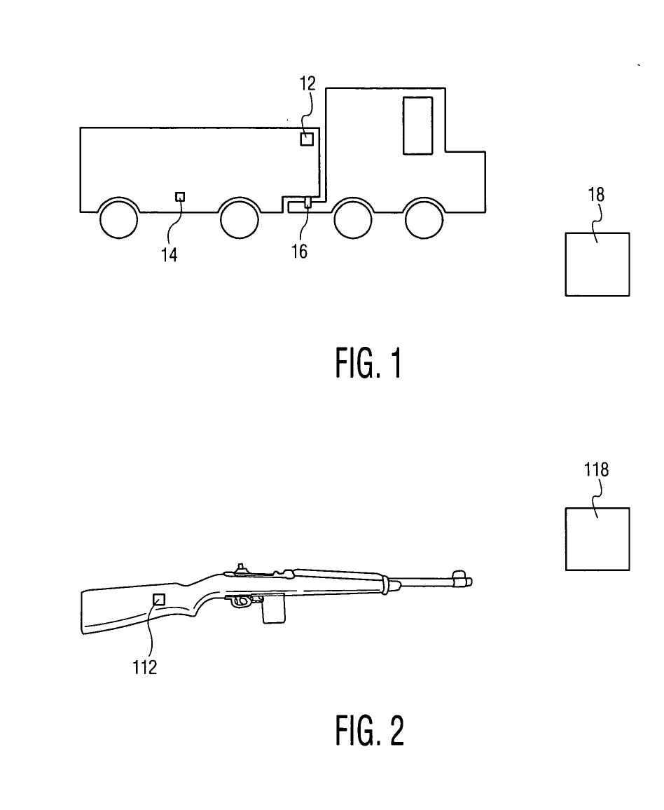

Referring now to the drawing in detail, wherein like reference numerals indicate like elements throughout the several views, there is illustrated in FIG. 1 an embodiment of a monitoring, tracking and recovery system in accordance with the present invention. As illustrated, embodiments of the present invention comprise a communication device adapted to be mounted in any desired location on a vehicle or on any other desired items, in order to communicate by wireless means with a remote data communications terminal. The communication device and remote data communications terminal can be provided in many different forms, as will be described in detail below. In one exemplary application, the communication device may be utilized for security purposes by monitoring, tracking and for recovery of vehicles. In certain situations, the threat of a vehicle getting into improper hands can even rise to the level of a homeland security concern, for instance, theft of any vehicles that may potentially be used for terroristic reasons, such as in connection with trailers/tankers that transport explosive liquids, such as gasoline or nitrate, radioactive materials or chemical waste, as examples.

In one embodiment, the communication device can comprise a wireless fidelity or WiFi chip or tag 12. WiFi technology generally defines a high-frequency wireless local area network (WLAN). WiFi is specified in the 802.11b specification from the Institute of Electrical and Electronics Engineers (IEEE). WiFi technology operates in the 2.4 GHz range offering data speeds up to 11 MB per second. A WiFi wireless LAN can be utilized with or without added security safeguards depending on the application and desires of the system.

In another embodiment, the communication device can comprise a global positioning system (GPS) chip 14 provided at any desired location on a vehicle or other item. The GPS system currently comprises an arrangement of 24 spaced satellites that orbit the earth, and which communicate with ground receivers to pinpoint geographic location. The location accuracy varies, and is anywhere from 100-10 meters for most equipment, and accuracy can be improved to within one meter with special approved equipment. The GPS is owned and operated by the U.S. Department of Defense, but is available for general use around the world.

In other embodiments, any other suitable wireless devices/protocols may be utilized, such as, for example and without limitation, cellular phones and other cellular devices, global systems for mobile communication (GSM), general packet radio service (GPRS), enhanced data GSM environment (EDGE), universal mobile telecommunication system (UMTSM), wireless application protocol (WAP) and I-Mode.

In accordance with embodiments of the present invention, one or more communication devices, such as a WiFi chip and/or GPS chip as examples, can be utilized and in either a powered or powerless format, in accordance with desires of the system. For example, in a communication device of the powerless type, any required power for operation can be provided by an external scanner or other similar type of remote data communications terminal. Alternatively, communication devices requiring a direct power connection for operation can be accomplished by any of a variety of suitable means. For example, the communication device can be powered by a vehicle motor or battery, as discussed in more detail below. The communication device may also be powered by an auxiliary battery located on a vehicle or other item, or by a solar battery source in connection with a communication device, as examples.

In one exemplary embodiment, the communication device can be provided at some desired location on a vehicle trailer and which is connected via a switch 16 to the motor/battery located in the cab portion of the vehicle. The switch is closed when the trailer is fixed to the cab and the switch is opened when the trailer and cab are disconnected. In this manner, the communication device is connected to and receives power from the motor/battery when the trailer and cab are in a mounted/hitched position. In addition, in this embodiment, one or more auxiliary batteries may be located on the trailer, and which provide back-up power to the communication device when either the trailer has been disconnected from the cab, there is a loss of power in the motor/battery, the engine has been turned off, or otherwise a malfunction in the connection between the communication device and motor/battery. Alternatively, the communication device can be a self contained mechanism, powered via any suitable power source, such as a battery or solar cell.

In still other embodiments, the communication device, such as the WiFi chip or GPS chip identified above, can be embedded into another device, such as into an inspection or registration sticker, as examples, which are in turn applied to a vehicle or other item. In this embodiment, as discussed above, the embedded communication device can similarly be of the powered or powerless type.

In addition, in accordance with embodiments of the present invention, a unique identifier can be tied to a particular vehicle, such as based on the vehicle identification number (VIN). Any other desired identifiers may be utilized as well, such as license number, social security number, company tax identification number, as examples. In this manner, the identity of the given vehicle may be obtained. As an example, a WiFi tag can store the VIN number of the vehicle and broadcast that information when the vehicle comes into the proximity of a scanner. The scanner, in turn, can be provided with a display that shows the VIN number of the vehicle. In addition, the scanner can be provided with a input mechanism, such as a keyboard, into which a particular VIN number desired to be located can be programmned in the scanner. In addition, an alarm or other indicator can be incorporated into the scanner to advise if a particular vehicle being tracked has come into proximity of the scanner.

In certain embodiments, one or both of a Wifi chip and GPS chip may be provided on a vehicle. For instance, the chip(s) designated above can be provided in a manner so that they can not be easily located, such as concealed or located in areas not easily accessible, such as underneath a vehicle, as example. In addition, the chip(s) can be engineered so as to be integrated into the vehicle itself, so as to avoid or inhibit removal. For example, a chip can be integrated into critical components, such as the motor, electrical system (i.e., wiring), or the battery, as examples. In this manner, removal of the chip(s) will render the vehicle inoperative. As indicated above, where the vehicle is a trailer or tanker, the chip(s) can be provided in the trailer portion that is being transported, and connected, such as via a switch, to a power source in the cab area. Disconnection of the trailer and cab portions results in a loss of power. An auxiliary battery can also be provided in the trailer portion to prevent a loss of power when the trailer and cab are disconnected. Alternatively, the chip(s) can be embedded in solar powered receptive paper, for instance, so as to be incorporated in an inspection or vehicle registration sticker, although other similar types of documents can be utilized as well for this purpose. The inspection/registration sticker can be of the cab and/or trailer portions.

The following will now describe an exemplary embodiment as to the operation of the system in accordance with the present invention. The relationship between the communication device and the remote data communications terminal 18 can be utilized in order to monitor, track and recover a vehicle where desired. In addition, where a unique identifier is utilized with the communication device, the specific owner or operator of the vehicle may be obtained as well. The remote data communications terminal can be provided in various forms, such as a scanner, and provided as portable or fixed devices at various locations. In one example, the location of a vehicle can be periodically monitored by placing a scanner at desired locations, such as at a toll booth as an example. The scanner, in turn, could monitor information, such as the location of a given vehicle at a particular time, and then store that information and/or transmit that information to some other location for receipt and/or storage. This can be done automatically at regular intervals, or on a demand basis, via an operator using a data communications system to locate a communication device associated with a particular vehicle. In this manner, the location of a given vehicle can be tracked, and similarly a stolen vehicle recovered where desired. For example, via a WiFi chip, by inputting a unique identifier of a particular trailer of interest into a scanner, and if that vehicle then comes into close proximity to the scanner, an alert signal can be triggered, such as an audible alarm. Also, via a GPS chip, by inputting a unique identifier into the GPS system, such as via a scanner, the location of the vehicle can be obtained via GPS tracking. As mentioned above, the unique identifier can come in many different forms. Advantageously, this can be accomplished easily and quickly. In some instances, time may be of the essence in order to recover a lost or stolen vehicle in order to prevent a possible disaster or breach in national security.

In another embodiment, communication devices, such as a WiFi chip or tag and/or a GPS chip, can be provided on other items as well, such as any components of a vehicle, items transported on a vehicle or any other desired items. Some examples include, such as in relation to components, a vehicle radio/video system; and such as in relation to items transported on a vehicle, valuable or dangerous cargo, for instance automobiles or radioactive containers; and finally any other desired items as well, such as paintings, furs, weapons, computers, etc. FIG. 2 illustrates a communication device 112, such as a WiFi tag or GPS chip, incorporated into a weapon, in particular a rifle, and a corresponding scanner 118. Information can be stored on the communication device, such as a WiFi chip, to identify a characteristic of the item, such as, for example, type of item, owner of the item, etc.

As discussed above, it should be understood that embodiments of the present invention can have particular application for national security reasons. As an example, an adaptation for a vehicle, such as, for example, trailers, tankers, trains, aircraft and subways, can be utilized to track and recover any lost or stolen vehicles quickly and effectively, which can be particularly important in certain situations to avoid a terroristic event or national disaster, such as with a tanker carrying dangerous or explosive materials. In addition, it may be desirable to recover a vehicle that has been car-jacked, especially where individuals are kidnapped as hostages.

In other embodiments related to national security, items that are potentially dangerous or harmful to the public at large, such as guns, knives, bombs, missiles, etc, can be equipped with communication devices, so as to be scanned and recognized by security personnel at designated locations, such as at toll booths, check points, border crossings, entrances to buildings, monuments, and public events, including sporting events, etc. In this manner, such potentially dangerous or harmful items that may be concealed will be found, for example, stored on a vehicle or carried on someone's person or in a bag, and if necessary, the items confiscated before a problem may occur. As an example, a WiFi tag located on a weapon can be programmed to broadcast a message that advises, “caution, there is a weapon nearby”. Similarly to that discussed above, any communication devices used can be concealed where desired.

Upon review of the foregoing, numerous adaptions, modifications, and alterations will occur to the reviewer. For example, the components described above can comprise commercially available components currently on the market, or specialty purpose hardware and/or software where desired. In addition, these components can utilize nanotechnology techniques where desired. These will all be, however, within the spirit of the invention. Accordingly, reference should be made to dependent claims in order to ascertain the true scope of the present invention.

1. A monitoring, tracking or recovery system for a vehicle comprising:
a communication device provided in association with a trailer portion of a vehicle and;
a remote data communications terminal remote from the vehicle adapted for at least one of one or two-way communication with the communication device in order to identify location of the vehicle at desired times.

2. A system according to claim 1, wherein the communication device requires power for the communication with the remote data communications terminal.

3. A system according to claim 2, wherein a switch is disposed between a trailer and cab portion of the vehicle and the switch is in a closed position when the trailer and cab are connected to allow the communication device to connect with and obtain power from the motor compartment of the vehicle contained in the cab area.

4. A system according to claim 3 further comprising an auxiliary power source located on a trailer and providing power to the communication device when the switch is opened occurring from disconnection of the trailer and cab portions.

5. A system according to claim 2, wherein the communication device is of the powerless type, being energized by the remote data communications terminal.

6. A system according to claim 3, wherein the power source is selected from the group consisting of battery, electricity and solar cell.

7. A system according to claim 1, wherein the communication device comprises a WiFi chip.

8. A system according to claim 1, wherein the communication device comprises a GPS chip.

9. A system according to claim 1, wherein the communication device is embedded into a registration sticker or inspection sticker.

10. A system according to claim 1, wherein a unique identifier associated with the vehicle is stored in the communication device.

11. A system according to claim 10 wherein a unique identifier corresponds to the VIN of the vehicle.

12. A monitoring, tracking or recovery system for an item comprising:
a communication device provided in association with portion of an item and;
a data communications terminal adapted for at least one of one or two-way communication with the communication device in order to identify a characteristic of the item at desired times.

13. A system according to claim 12, wherein the communication device requires power for the communication with the data communications terminal.

14. A system according to claim 13, wherein the characteristic of the item comprises at least one of type of the item and owner of the item.

15. A system according to claim 12 further comprising an auxiliary power source located on the item and providing power to the communication device.

16. A system according to claim 13, wherein the communication device is of the powerless type, being energized by the data communications terminal.

17. A system according to claim 12, wherein the power source is selected from the group consisting of battery, electricity and solar cell.

18. A system according to claim 12, wherein the communication device comprises a WiFi chip.

19. A system according to claim 12, wherein the communication device comprises a GPS chip.

20. A system according to claim 12, wherein the communication device is embedded into a document.

21. A system according to claim 12, wherein a unique identifier associated with the item is stored in the communication device.
